(19) United States
(12) Patent Application Publication
(10) Pub. No.: US 2004/0169662 A1
(43) Pub. Date: Sep. 2, 2004

(54) Arrangement of icons of network components on a screen

(76) Inventors: Uwe Riemann, Braunschweig (DE); Hans-Joachim Platte, Hemmingen (DE); Ingo Hutter, Pattensen (DE)

Correspondence Address: Joseph S Tripoli, Thomson Multimedia Lincensing, Patent Operations, CN 5312, Princeton, NJ, 08543-0028, US

(21) Appl. No.: 10/480,777

(22) PCT Filed: Jun. 10, 2002
(86) PCT No.: PCT/EP02/06295

(30) Foreign Application Priority Data
Jun. 22, 2001 (DE) 101 29 708.4

(51) Int. Cl. G09G 5/00

(52) U.S. Cl. 345/619

(57) ABSTRACT

The targeted driving of a network component is intended to be facilitated for the user. Therefore, the icons (I1, I2, I4, I5, I6) of the network components are always represented at desired, fixed display locations of a screen (4). The display locations are either read directly from the network component or determined via the Global Unique Identifier GUID.

The present invention relates to an apparatus and a method for displaying network components by representation of the network components incorporated in a network by a respective unique identifier on a display device.

It is with growing interest that the consumer electronics industry is pursuing the networking of multimedia devices in the private domestic environment. The starting point is the multiplicity of different device types and device connections in particular of audio/video devices (AV), which in many cases can be connected together and utilized only with a considerable outlay. Thus, by way of example, the playback of a video film in the living room —including the control of the recorder there—via the television in the bedroom is generally impossible or can be realized only by means of a highoutlay on cabling. However, in order to ensure an attractive interoperability of multimedia devices, it is possible to use home networks, as are described in U. Riemann: “Digital Home Network (DHN)”, FERNSEH-UND KINO-TECHNIK, volume 54, No. 12/2000, pages 752 to 758.

Leading consumer electronics manufacturers have joined together to form a committee in order to develop a standardized operating system for home network applications on the basis of the high-speed data bus IEEE 1394. This operating system is known under the name HAVi (Home Audio Video Interoperability). The expressions and abbreviations used below are defined in greater detail in the HAVi specification (version 1.0).

With the advent of networking of terminal devices in the home, there is a need to display to the user a graphical representation of all his devices in the network interconnection. This is normally realized in the form of small symbolic pictures (icons) which are displayed to the user on a screen, e.g. the television.

The individual components of the network interconnection are generally incorporated into the network in a random order. This random configuration of the home network by arbitrarily interconnecting existing devices results in a situation-dictated arrangement of the icons on the screen. When there are a large number of network components, this has the result that the user must, under certain circumstances, laboriously search for the icon of a desired device.

Consequently, the object of the present invention is to facilitate the targeted driving of a network component for the user.

According to the invention, this object is achieved by means of a method for displaying network components by representation of each network components incorporated in a network by a respective unique identifier on a display device, and assignment of a display location on the display device to a network component independently of an incorporation of the network component into the network so that the network component is represented with its identifier at the display location on the display device if the network component is incorporated into the network.

Furthermore, the above object is achieved by means of an apparatus for displaying network components having a display device for representing the network components of a network and a control device for assigning a respective display location on the display device to each of the network components, and also having a memory device for storing the display location or an assignment table via which an individual display location can be assigned to each network component by the control device.

This advantageously makes it possible to realize, for the operation of devices in home networks, a specific arrangement of the icons which is prescribed e.g. by a user and corresponds to his personal preference, so that the user can find the icons very quickly and effortlessly. This arrangement of the icons can be retained independently of the order or way in which the devices have been and are configured to form a network.

The present invention will now be explained in more detail with reference to the accompanying drawings, in which:

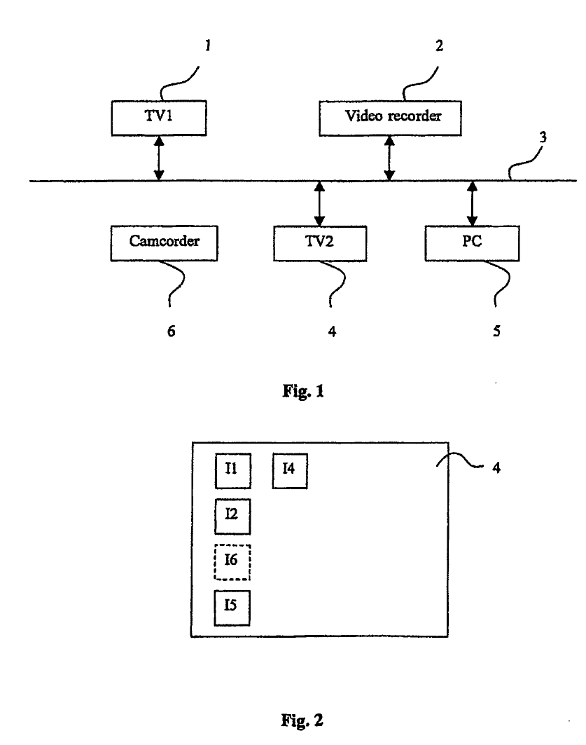

FIG. 1 shows network components in a digital home network; and

FIG. 2 shows the arrangement of icons representing the network components of FIG. 1 on a screen.

The exemplary embodiment described below represents a preferred embodiment of the present invention.

FIG. 1 diagrammatically reproduces a first television 1 and a video recorder 2, which are connected to an IEEE 1394 network 3. Furthermore, a second television 4 and a computer 5 are connected to the network 3. At least one controller, which is not illustrated and is provided with an HAVi implementation, must be situated as a separate unit or in one or more of the network components 1, 2, 4, 5. If a controller is situated in one of the network components, then the latter is referred to as IAV (Intermediate AV Device) or FAV (Full AV Device), depending on the degree of implementation of the HAVi software elements. The remaining network components then do not have to be provided with such a controller and can be so-called BAV devices (Base AV Device) or LAV devices (Legacy AV Devices), i.e. devices with limitedsor less inherent intelligence.

In the one or the plurality of HAVi controllers (all the devices or components of the network are represented by a so-called DCM (Device Control Module) in each case. A DCM converts the generic commands of the HAVi operating system into device-specific commands. For completely satisfactory identification, the DCMs have a specific identification identifier, the so-called SEID (Software Element Identifier). However, the latter is generated dynamically, so that, after the configuration of a network or the incorporation of a new network component, it cannot be assumed that a DCM assigned to a device or a component always has the same SEID. Rather, the SEID for a device newly incorporated into the network will be generated depending on the status of the existing network. Therefore, the SEID cannot be used as arrangement criterion for the graphical representation of a device.

However, each DCM comprises a so-called HUID (HAVi Unique Identifier). A constituent part of this HUID is the GUID (Global Unique Identifier) of the device which is represented by the DCM. the GUID is unique and invariable for each device. This means that, despite different SEIDs, the GUID can be obtained as unique device identifier from the HUID of each DCM. This unique identification identifier can be linked with a corresponding display location for example via a look-up table. Consequently, for each device, it is possible to obtain a unique criterion for the arrangement of the graphical representation for a device from the network.

For the central management of the GUIDs of the devices in the network, the GUIDs can be stored in a memory of the network control device or HAVi controller or else be stored in any other memory to which the control device has access. The display location of the icons of the various network components can then be produced directly from the storage order of the GUIDs in the memory or else from an assignment of theGUIDs to locations of a display pattern.

FIG. 2 shows by way of example how, on the screen of the television set 4, icons of the individual network components 1, 2, 4, 5, 6 can be arranged in a user-specific pattern. The icons I1 and I4 represent the two television sets 1 and 4, the icons I2, I6 and I5 represent the video recorder 2, the camcorder 6 and the computer 5. The user is accustomed exactly to this pattern and will always search for television sets, for example, in the first row.

In the present example, the camcorder 6, as can also be seen from FIG. 1, is not connected to the network 3. In FIG. 2, this is indicated by an icon I6 with broken lines. This icon I6 can be completely blanked out or be displayed as shadow, for example, by means of a placeholder. In both cases, the display location is kept free for the camcorder 6. If the camcorder 6 is then connected to the network the associated icon I6 will be inserted at the location which is familiar to the user and is indicated in FIG. 2.

FIG. 2 illustrates a simple pattern in which the icons can be arranged on the screen. As already indicated, the icons can also be represented merely in a user-specific order. Thus, by way of example, a user may wish to display firstly the icon of a washing machine which is integrated into the network, and then the icons of other devices, such as shutters, computer, etc. Such an order of icons could be represented in rows or columns.

In the above exemplary embodiment, the representation location of an icon is determined by the control device using the unique GUID. As an alternative, however, the display location could also be stored directly in the display component. The network control device could read out the stored display location and use it directly as a basis for the display on the screen. This would have the advantage that a network component can be reproduced in different networks at the absolutely or relatively identical position of the network-specific icon representation. Thus, by way of example, it is possible to have an icon of a specific device always displayed in the centre of the screen or e.g. at the third position. A typical application example in this respect would be if a user wishes to operate his camcorder both in the network of his home and in the network of his holiday residence and always to find the icon of the camcorder at an accustomed location.

The network component advantageously has a memory in which its individual display location in the network 3 is stored. If it is incorporated into a network in which it had not yet previously been incorporated, then the stored display location is preferably the one on which it is automatically positioned. If the user, for this network, selects a different display location for this network component, then this is also stored in the memory device of the network component. Thus, the network component has different fixed display locations, if appropriate, for different networks. This is advantageous particularly when a device is used by different users with different preferences in different networks, for example a camcorder which is used by a number of family members and is incorporated in the respective private networks thereof.

For the case where a table is created which stores what icon assigned to a GUID the user would like to have displayed where, problems can arise in the storage of locations of the icons of new devices if not all the network components are present at the time of inserting a new device in the network. This shall be explained using an example. Suppose that a network has 10 components whose icons have been arranged in a specific order by a user. Furthermore, suppose that half of the devices have been temporarily removed from the network and a new, eleventh device is added to the five devices still present. Moreover, suppose that the user positions the icon between two device icons between which two icons of devices removed from the network have previously been positioned. In this case, it is not possible to assign a unique storage location to the new icon. In principle, the following solution approaches exist for this problem:

1. The new icon is positioned at an arbitrary position between the other two visible icons in the table. In this case, in the event of reincorporation of the removed devices, the user would possibly have to define a new position for said devices.

2. Tables with absolute positions are not stored, but rather only lists with relative positions. The GUID considered follows, for example, GUID X and comes before GUID Y. In the case of this method, each time the icon list is built up, the optimum arrangement of all the icons would have to be determined in a kind of parser operation.

The invention is not restricted to HAVi networks. Rather, it can also be applied to networks with devices which do not correspond to the HAVi standard. The controller of such a network must identify all the devices which are present in the network. To that end, each device must provide a unique device identifier, e.g. GUID, in the network. In the case of using a GUID, obtaining it would not then require a detour via the HUID. The display order or the display pattern is produced according to the GUID again as in the previous exemplary embodiment.

List of Reference Symbols

1 First television

2 Video recorder

3 IEEE 1394-network

4 Second television

5 Computer

I1, I2, I4, I5, I6 Icons

IAV Intermediate AV Device

FAV Full AV Device

BAV Base AV Device

LAV Legacy AV Device

DCM Device Control Module

SEID Software Element Identifier

HUID HAVi Unique Identifier

GUID Global Unique Identifier

1. Method for displaying network components by
representing of the network components incorporated in a network on a display device by a respective unique identifier (I1, I2, I4, I5, I1),
assigning of an absolute or relative display location on the display device (4) to a network component (1, 2, 4, 5, 6),
characterized by
simultaneously displaying the respective unique identifiers (I1, I2, I4, I5, I6) of the network components incorporated in the network in an order defined by said assigned display locations.

2. Method according to Claim 1, wherein the identifier (I1, I2, I4, I5, I6) is a symbol, in particular an icon.

3. Method according to claim 1 or 2, wherein the display location is stored in the network component (1, 2, 4, 5, 6) and is read out from the network component in the event of incorporation into a network (3).

4. Method according to one of claims 1 to 3, wherein each network component (1, 2, 4, 5, 6) is allocated an individual identification identifier, and the assignment of a display location is effected using the identification identifier.

5. Method according to claim 4, wherein the identification identifier is the GUID of the network component (1, 2, 4, 5, 6).

6. Method according to one of claims 1 to 5, wherein in the event of incorporation of a network component whose absolute display location is already allocated, a new absolute display location is defined for one or a plurality of affected network component (a).

7. Apparatus for displaying network components having a display device (4) for representing the network components (1, 2, 4, 5, 6) of a network (3) by respective unique identifiers (I1, I2, I4, I5, I6), and a control device for assigning a respective display location on the display device (4) to each of the network components (1, 2, 4, 5, 6),
characterized in that
said control device controls simultaneous display of said respective unique identifiers (I1, I2, I4, I5, I6) of the network components incorporated in the network in an order defined by said assigned display locations.

8. Apparatus according to claim 7, further comprising a memory device for storing the display location or an assignment table via which an individual display location can be assigned to the network components (l, 2, 4, 5, 6) by the control device.

9. Apparatus according to claim 7 or 8, wherein each network component (1, 2, 4, 5, 6) can be represented by a specific identifier (I1, I2, I4, I5, I6), in particular icon, on the display device (4).

10. Apparatus according to any of claims 7 to 9, wherein the network (3) is an IEEE 1394 network.

11. Apparatus according to any of claimr 7 to 10, wherein the control device is an H&Vi controller.

12. Apparatus according to any of claims 7 to 11, wherein each network component (1, 2, 4, 5, 6) can be represented in the control device by a software element, in particular a device control module, which comprises a unique identification identifier for the network component (1, 2, 4, 5, 6), and an evaluation device is provided with which the identification identifier, in particular a GUID, can be extracted from the software element.

13. Network component (1, 2, 4, S, 6) for incorporation into a network (3), a unique identifier zo (I1, I2, I4, 15, I6) being assigned to the network component (1, 2, 4, 5, 6) on a display device (4) of the network (3),
characterized
in that the network component (1, 2, 4, 5, 6) has a memory device for storing the display location of the identifier (I1, I2, I4, I5, I6) assigned to it in a network (3), or an assignment table via which an individual display location can be assigned to it.
